(19) United States
(12) Patent Application Publication
(10) Pub. No.: US 2024/0244540 A1
(43) Pub. Date: Jul. 18, 2024

(54) TRANSMISSION POWER DETERMINATION FOR FORWARDING NODES IN WIRELESS COMMUNICATION SYSTEMS

(71) Applicant: ZTE Corporation, Shenzhen (CN)

(72) Inventors: Wei CAO, Shenzhen (CN); Nan ZHANG, Shenzhen (CN); Ziyang LI, Shenzhen (CN); Yachao YIN, Shenzhen (CN)

(73) Assignee: ZTE Corporation, Shenzhen, GD (CN)

(21) Appl. No.: 18/622,243

(22) Filed: Mar. 29, 2024

Related U.S. Application Data
(63) Continuation of application No. PCT/CN2022/075447, filed on Feb. 8, 2022.

(51) Int. Cl. H04W 52/36; H04W 52/24

(52) U.S. Cl. CPC H04W 52/367; H04W 52/242

(57) ABSTRACT

This document generally relates to systems, apparatuses, devices, and methods for wireless communication that includes a forwarding node that receives a signal from a first communication node, determines a transmission power value for transmission of the signal, and transmits the signal to a second communication node according to the transmission power value. The transmission power value is dependent on a forwarding mode of the forwarding node or a forwarding link between the forwarding node and the second communication node.

### CROSS-REFERENCE TO RELATED APPLICATIONS

This application is a continuation of International Application No. PCT/CN2022/075447, filed Feb. 8, 2022. The contents of International Application No. PCT/CN2022/075447 are herein incorporated by reference in their entirety.

### TECHNICAL FIELD

This document is directed generally to forwarding nodes for wireless communication.

### BACKGROUND

As New Radio (NR) communication systems move to higher frequencies (around 4 Gigahertz (GHz) for frequency ranges FR1 and above 24 GHz for frequency ranges FR1), propagation conditions degrade compared to lower frequencies, which exacerbates coverage challenges. Accordingly, further densification of cells may be desirable. While the deployment of full-stack cells may be preferable, it may not always be possible (e.g., no availability of backhaul) or be an economically viable option. To provide blanket coverage in cellular network deployments with relatively low cost, radio frequency (RF) repeaters with full-duplex amplify-and-forward operation have been used in 2G, 3G, and 4G systems. However, such repeaters undesirably operate in an always-on manner (e.g., amplify and forward all signals, including noise, they receive) and forward signals in an omni-directional manner, which in turn, increase unwanted interference (pollution) in the systems. Other types of communication nodes instead of such RF repeaters that can provide reduced or minimized interference and/or improved power consumption may be desirable.

### SUMMARY

This document relates to methods, systems, apparatuses and devices for wireless communication. In some implementations, a method for wireless communication includes: receiving, with a forwarding node, a signal from a first communication node; determining, with the forwarding node, a transmission power value for transmission of the signal, the transmission power value dependent on a forwarding mode of the forwarding node or a forwarding link between the forwarding node and a second communication node; and transmitting, with the forwarding node, the signal to the second communication node according to the transmission power value.

In some other implementations, a device, such as a network device, is disclosed. The device may include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causing the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a forwarding node for establishing control and forwarding links with a wireless access node and a user device.

FIG. 3 shows a flow chart of an example method of wireless communication.

### DETAILED DESCRIPTION

The present description describes various embodiments of systems, apparatuses, devices, and methods for wireless communications involving aggregation links between user devices. Such apparatuses, systems, and/or methods may allow higher data rates and/or higher reliability for a primary user device, and/or may enable communication between the primary user device and the network, even if the primary user device is out of network coverage.

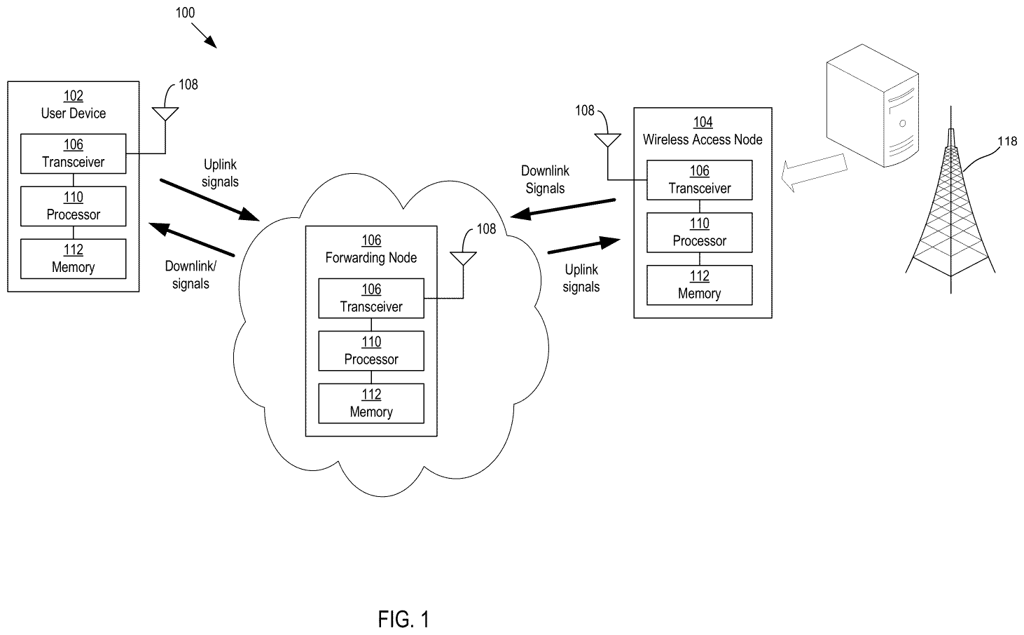

FIG. 1 shows a diagram of an example wireless communication system 100 including a plurality of communication nodes (or just nodes) that are configured to wirelessly communicate with each other. In general, the communication nodes include at least one a user device 102, at least one wireless access node 104, and at least one forwarding node 106. The example wireless communication system 100 in FIG. 1 is shown as including one user devices 102, one wireless communication node 104, and one forwarding node 106. However, various other examples of the wireless communication system 100 that include any of various combinations of one or more user devices 102, one or more wireless access nodes 104, and one or more forwarding nodes 106.

As shown in FIG. 1, each communication node, including each user device 102, wireless access node 104, and forwarding node, may include transceiver circuitry 106 coupled to an antenna 108 to effect wireless communication with one or more other communication nodes. The transceiver circuitry 106 may also be coupled to a processor 110, which may also be coupled to a memory 112 or other storage device. The memory 112 may store therein instructions or code that, when read and executed by the processor 110, cause the processor 110 to implement any of the actions, functions, and/or methods described herein Additionally, in general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples).

Also, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In addition, two communication nodes in the wireless system 100—such as a user device 102 and a wireless access node 104, a user device 102 and a forwarding node 106, or a wireless access node 104 and a forwarding node 106—may be configured to wirelessly communicate with each other in or over a mobile network and/or a wireless access network according to one or more standards and/or specifications. In general, the standards and/or specifications may define the rules or procedures under or according to which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Correspondingly, a given communication may have a type of direction corresponding to the type of signal being communicated. For example, an uplink signal is communicated in an uplink direction, a downlink signal is communicated in a downlink direction, and a sidelink signal is communicated in a sidelink direction.

In addition, the forwarding node 106 (also called a smart node (SN)) is a communication node that forwards signals between user devices 102 and wireless access nodes 104. For example, the forward node 106 forwards downlink signals in the downlink direction from the wireless access node 104 to the user device 102. For such communications, the forwarding node 106 receives a downlink signal from the wireless access node 104, and in response, transmits the downlink signal to the user device 102. In addition, the forwarding node forwards uplink signals in the uplink direction from the user device 102 to the wireless access node 104. For such communications, the forwarding node 106 receives an uplink signal from the user device 102, and in response, transmits the uplink signal to the wireless access node 104.

Also, in various embodiments, the forwarding that the forwarding node 106 performs may be an intelligent, dynamic, controllable, or selective amplify-and-forward operation, in that the direction (e.g., through beam forming or selection) and/or the power or amplitude at, or according to which, the forwarding node 106 transmits or forwards a signal may be controllable and/or adjustable. In various embodiments, including those described below, the wireless access node 104 may control, set, and/or adjust the direction and/or power according to which the forwarding node 106 transmits or forwards a signal.

Additionally, in various embodiments, the forwarding node 106, the wireless access node 104, and the user device 102 may communicate according to time-division multiplexing (TDM), frequency-division multiplexing (FDM), or combinations thereof. For example, in the downlink direction, the wireless access node 104 may multiplex data and/or control information to be received by the forwarding node 106 and/or forwarded to the user device 102 according to FDM techniques (i.e., in the frequency domain) and/or according to TDM techniques (i.e., in the time domain). Additionally, in the uplink direction, the user device 102 and/or the forwarding node 106 may multiplex data and/or control information to be received by the wireless access node 104 according to TDM techniques (i.e., in the time domain).

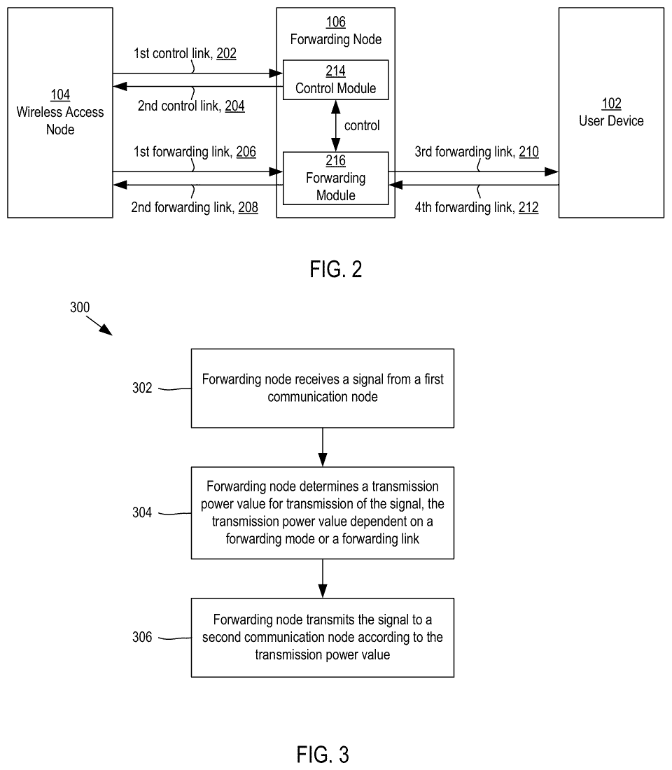

FIG. 2 shows a block diagram of an example configuration of the forwarding node 106 to establish control and forwarding links with the wireless access node 104 and the user device 102. In general, a control link is a communication link between the wireless access node 104 and the forwarding node 106 that the wireless access node 104 and the forwarding node 106 use to communicate control information and/or control messages or signals carrying the control information, and response messages corresponding to the control messages between each other. An example type of control information may include scheduling information that is used for scheduling time and frequency resources for communication of a signal, such as an uplink signal or a downlink signal, that the forwarding node 106 receives and forwards between the user device 102 and the wireless access node 104. Another example type of control information may include transmission power information that indicates a transmission power value, or instructs the forwarding node 106 how to determine a transmission power value, to use for the transmission power when transmitting or forwarding a signal. Another type of control information may include information used to establish one or more of the communication links, including one or more of the control links and/or one or more of the forwarding links. Other types of control information may be possible, such as in accordance with any of various wireless communication standards or protocols, and/or as described in further detail below. FIG. 2 shows the forwarding node 106 and the wireless access node 104 configured to establish two control links, including a first control link 202 over which the wireless access node 104 transmits control information and/or response information to control information to the forwarding node 106, and a second control link 204 over which the forwarding node 106 transmits control information and/or response information to control information to the wireless access node 104.

Also, a forwarding link is a communication link between the forwarding node 106 and the wireless access node 104 or between the forwarding node 106 and the user device 102 used to communicate a signal, such as an uplink signal or a downlink signal, that the wireless access node 104 and the user device 102 want communicated between each other. The forwarding node 106 may establish and/or use a plurality of forwarding links for communication with the wireless access node 104 and the user device 102. For example, the wireless access node 104 may transmit a downlink signal to the forwarding node 106 over a forwarding link, and in response, the forwarding node 106 may forward or transmit the downlink signal to the user device 102 over another forwarding link. As another example, the user device 102 may transmit an uplink signal to the forwarding node 106 over a forwarding link, and in response, the forwarding node 106 may forward or transmit the uplink signal to the wireless access node 104 over another forwarding link. FIG. 2 shows the forwarding node 106 configured to establish four forwarding links, including a first forwarding link 206 used to transmit downlink signals from the wireless access node 104 to the forwarding node 106, a second forwarding link 208 used to transmit uplink signals from the forwarding node 106 to the wireless access node 104, a third forwarding link 210 used to transmit downlink signals from the forwarding node 106 to the user device 102, and a fourth forwarding link 212 used to transmit uplink signals from the user device 102 to the forwarding node 106.

Additionally, as shown in FIG. 2, for at least some embodiments, the forwarding node 106 may include a control module (or unit) 214 and a forwarding module (or unit) 216. The control module 214 may establish the control links 202, 204 with the wireless access node 104, receive and/or process the control information and/or responses to control information received from the wireless access node 104 via the first control link 202, and/or generate and/or transmit control information and/or responses to control information to the wireless access node 104 via the second control link 204. The forwarding module 216 may establish the forwarding links 206, 208, 210, 212 between the forwarding node 106 and the wireless access node 104 and user device 102, receive and/or process signals, including uplink signals and downlink signals received via the forwarding links 206-212, and/or generate, amplify, transmit, and/or forward signals, including uplink and downlink signals, to the wireless access node 104 and user device 102.

In addition, the control module 214 and the forwarding module 216 may be in communication with each other. In various embodiments, the control module 214 may send control information to the forwarding module 216, which the forwarding module 216 may use to perform one or more of its functions, such as establish the forwarding links 206-212 or process or generate signals the forwarding module 216 receives or transmits. For example, the control module 214 may send control information to the forwarding module 216 that indicates, or otherwise includes information that the forwarding module 216 uses to determine, a transmission power value according to which the forwarding module 216 transmits or forwards a signal.

Also, as used herein unless expressed otherwise, the terms “module” and “unit”, as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

FIG. 3 shows a flow chart of an example method 300 for wireless communication related to the forwarding node 106 using a transmission power value for communication of a signal. At block 302, the forwarding node 106 may receive a signal from a first communication node. The received signal may be intended for a second communication node. For example, in some embodiments, the first communication node is the wireless access node 104, the second communication node is the user device 102, and the signal is a downlink signal. For at least some of these embodiments, the forwarding node 106 may receive the downlink signal via the first forwarding link 206 shown in FIG. 2. For other embodiments, the first communication node is the user device 102, the second communication node is the wireless access node 104, and the signal is an uplink signal. For at least some of these embodiments, the forwarding node 106 may receive the uplink signal via the fourth forwarding link 212.

At block 304, the forwarding node 106 may determine a transmission power value for transmission of the signal. The transmission power value is a value of the transmission power at or according to which the forwarding node 106 transmits the signal it receives at block 302. For example, the power of the signal transmitted by the antenna 108 of the forwarding node 106 may correspond to or depend on the transmission power value determined at block 304.

Additionally, the transmission power value may be dependent on a forwarding mode of the forwarding node 106 or a forwarding link between the forwarding node 106 and the second communication node. In general, the forwarding node 106 may be configured to operate in a plurality of operation modes, one of which is a forwarding mode. Another operation mode may be a control mode. In the forwarding mode, the forwarding node 106 communicates, including receiving and transmitting or forwarding, signals over forwarding links. Accordingly, when operating in the forwarding mode, the forwarding node 106 may receive a signal from a first communication node via a first forwarding link, and transmit or forward the signal to a second communication node via a second forwarding link. As mentioned, the forwarding node 106 may utilize the forwarding module 216 when operating in the forwarding mode. In the control mode, the forwarding node 106 communicates and/or processes control information and/or responses to control information with the wireless access node 104 via one or more control links. The forwarding node 106 may utilize the control module 214 when operating in the control mode.

At block 304, for embodiments where the forwarding node 106 determines a transmission power value dependent on the forwarding mode, the forwarding node 106 may determine a transmission power value for a transmission based or dependent on which operation mode the forwarding node 106 is operating in. For situations where the forwarding node 106 is operating in the control mode and communicating control information via the control links 202, 204 with the wireless access node 104, the forwarding node 106 may determine a transmission power value for a transmission of control information or a response to control information over the second control link 204 to the wireless access node 104 that is based or dependent on the forwarding node 106 operating in the control mode. In various embodiments, the forwarding node 106 may determine the transmission power value to be the same as that used for transmitting downlink reference signals (DL RS) and/or uplink (UL) physical channels, such as in accordance with NR standards or specifications. In addition, for situations where the forwarding node 106 is operating in the forwarding mode and communicating signals via one or more of the forwarding links 206-212, the forwarding node 106 may determine a transmission power value for a transmission or forwarding of the received signal that is based or dependent on the forwarding node 106 operating in the forwarding mode.

Additionally, in various embodiments, the transmission power values that the forwarding node 106 uses when operating in the control mode and when operating in the forwarding mode may be different from each other. In addition or alternatively, the transmission power values may be derived or calculated in different manners.

In various embodiments, the wireless communication system 100 may include a transmission power determination module configured to determine, derive, or calculate one or more transmission power values. In some embodiments, the transmission power determination module may be a component of the forwarding node 106. For other embodiments, the transmission power determination module may be a component of the wireless access node 104, the user device 102, or another communication node in the wireless communication system 100. For these other embodiments, the other communication node that includes the transmission power determination module may determine a transmission power value, and transmit or provide the transmission power value to the forwarding node 106. Correspondingly, at block 304, the forwarding node 106 may determine a transmission power value for transmission or forwarding of a signal by determining a transmission power value that the transmission power determination module determined or calculated.

Additionally, in some embodiments, the transmission power determination module may determine at least one transmission power value for the forwarding node 106 to use when operating in the forwarding mode. For at least some of these embodiments, the transmission power determination module may determine a transmission power value based on a maximum transmission power for the forwarding node 106, a received signal power of the forwarding node 106, and an amplification gain. In particular of these embodiments, the transmission power determination module may determine the transmission power value to be, or based on, a minimum of the maximum transmission power and a sum of the received signal power and the amplification gain, such as according to the following mathematical formula:

$${P}_{FN} = min \{ {P}_{FN , max} , {P}_{Rx} + {g}_{amp} \} \qquad ( 1 )$$

where P_{FN} is the transmission power value, P_{FN,max} is the maximum transmission power, P_{Rx} is the received signal power, and gₐₘₚ is the amplification gain.

In addition, in some of these embodiments where the forwarding node 106 uses a transmission power value dependent on the forwarding mode, the transmission power determination module may be configured to determine a single transmission power value that is applicable for both forwarding directions, i.e., for both the uplink direction and the downlink direction. Accordingly, when the forwarding node 106, operating in the forwarding mode, receives a signal to be forwarded to the second communication node, the forwarding node 106 may use a transmission power value for the forwarding mode, irrespective of or without determining whether the signal is received and to be forwarded in the uplink direction or the downlink direction. In other of these embodiments, the transmission power determination module may determine multiple transmission power values, one for the uplink direction and another for the downlink direction. Accordingly, when the forwarding node 106, operating in the forwarding mode, receive a signal to be forwarded to the second communication node, the forwarding node 106 may determine or select a transmission power value corresponding to the forwarding direction of the received signal. That is, if the received signal is a downlink signal, the forwarding node 106 may determine a transmission power value corresponding to the downlink direction, and if the received signal is an uplink signal, the forwarding node 106 may determine a transmission power value corresponding to the uplink direction.

Correspondingly, in at least some of these embodiments where the forwarding node 106 uses the same transmission power value for both the uplink and downlink directions, the transmission power determination module may use the same maximum transmission power value for both forwarding directions when determining the transmission power value for the forwarding node 106. Also, for at least some of the embodiments where the forwarding node 106 uses different or separate transmission power values for the uplink and downlink directions, the transmission power determination module may use different or separate maximum transmission power values for the different uplink and downlink directions when determining the transmission power values for the forwarding node 106.

Additionally, for at least some embodiments, including those where the transmission power determination module is a component of a communication node other than the wireless access node 104, such as the forwarding node 106, the wireless access node 104 may send the maximum transmission power value (or values) to the communication node configured with the transmission power determination module. Also, for at least some of these embodiments, when sending a given maximum transmission power value, the wireless access node 104 may also send a forwarding direction flag that indicates whether to use the given maximum transmission power value for both forwarding directions, for only the uplink direction, or for only the downlink direction. Accordingly, in some embodiments, the wireless access node 104 may send a maximum transmission power value to the other communication node with a forwarding direction flag that indicates to use the maximum transmission power value for both forwarding directions. In turn, the transmission power determination module may determine a power transmission value that is applicable for both forwarding directions, and the forwarding node 106 may use that power transmission value for both forwarding directions. In other embodiments, the wireless access node 104 may send first and second maximum transmission power values to the other communication node with at least one forwarding direction flat that indicates that the first maximum transmission power value is for the uplink direction, and the second maximum transmission power value is for the downlink direction. In turn, the power transmission determination module determines a first transmission power value based on the first maximum transmission power value and a second transmission power value based on the second maximum transmission power value. Correspondingly, the forwarding node 106 uses the first transmission power value for forwarding uplink signals and the second transmission power value for forwarding downlink signals.

In other embodiments, including those where the transmission power determination module is a component of the forwarding node 106, the wireless access node 104 may include one or more maximum transmission power values in a scheduling message, such as a downlink control information (DCI) message, that it sends to the forwarding node 106, such as over the first control link 202. For at least some of these embodiments, the scheduling message may be for a particular or specific forwarding direction, and/or may indicate a particular forwarding direction for each of the one or more amplification gain values included in the scheduling message.

In other embodiments, the wireless access node 104 may provide a maximum transmission power value to the transmission power determination module only for the downlink direction. Correspondingly, the forwarding node 106 may use transmission power value dependent on the forwarding mode for the downlink direction only. For the uplink direction, the forwarding node 106 may use a transmission power value that it also uses when operating in the control mode for transmissions to the wireless access node 104 over the second control link 204.

In addition or alternatively, in at least some of these embodiments where the forwarding node 106 uses the same transmission power value for both the uplink and downlink directions, the transmission power determination module may use the same amplification gain value for both forwarding directions when determining the transmission power value for the forwarding node 106. Also, for at least some of the embodiments where the forwarding node 106 uses different or separate transmission power values for the uplink and downlink directions, the transmission power determination module may use different or separate amplification gain values for the different uplink and downlink directions when determining the transmission power values for the forwarding node 106.

Additionally, for at least some embodiments, including those where the transmission power determination module is a component of a communication node other than the wireless access node 104, such as the forwarding node 106, the wireless access node 104 may send the amplification gain value (or values) to the communication node configured with the transmission power determination module. Also, for at least some of these embodiments, when sending a given amplification gain value, the wireless access node 104 may also send a forwarding direction flag that indicates whether to use the given amplification gain value for both forwarding directions, for only the uplink direction, or for only the downlink direction. Accordingly, in some embodiments, the wireless access node 104 may send an amplification gain value to the other communication node with a forwarding direction flag that indicates to use the amplification gain value for both forwarding directions. In turn, the transmission power determination module may determine a power transmission value that is applicable for both forwarding directions, and the forwarding node 106 may use that power transmission value for both forwarding directions. In other embodiments, the wireless access node 104 may send first and second amplification gain values to the other communication node with at least one forwarding direction flat that indicates that the first amplification gain value is for the uplink direction, and the second amplification gain value is for the downlink direction. In turn, the power transmission determination module determines a first transmission power value based on the first amplification gain value and a second transmission power value based on the second amplification gain value. Correspondingly, the forwarding node 106 uses the first transmission power value for forwarding uplink signals and the second transmission power value for forwarding downlink signals.

In other embodiments, including those where the transmission power determination module is a component of the forwarding node 106, the wireless access node 104 may include one or more amplification gain values in a scheduling message, such as a downlink control information (DCI) message, that it sends to the forwarding node 106, such as over the first control link 202. For at least some of these embodiments, the scheduling message may be for a particular or specific forwarding direction, and/or may indicate a particular forwarding direction for each of the one or more amplification gain values included in the scheduling message.

In addition, at block 304, for embodiments where the forwarding node 106 determines a transmission power value dependent on a forwarding link, the forwarding node 106 may determine a transmission power value for a transmission based or dependent on the transmission being on a forwarding link, as opposed to the transmission being on a control link. For situations where the forwarding node is to transmit on a control link, such as the second control link 204, the forwarding node 106 may determine a transmission power value for a transmission of control information or a response to control information over the second control link 204 to the wireless access node 104 that is based or dependent on the transmission being over a control link. In various embodiments, the forwarding node 106 may determine the transmission power value to be the same as that used for transmitting downlink reference signals (DL RS) and/or uplink (UL) physical channels, such as in accordance with NR standards or specifications. In addition, for situations where the forwarding node 106 is to transmit over one of the forwarding links 206-212, the forwarding node 106 may determine a transmission power value for a transmission or forwarding of the received signal that is based or dependent on the forwarding node 106 transmitting or forwarding over a forwarding link.

Additionally, in various embodiments, the transmission power values that the forwarding node 106 uses when transmitting over a control link and when transmitting over a forwarding link may be different from each other. In addition or alternatively, the transmission power values may be derived or calculated in different manners.

Also, in various embodiments where the transmission power value is dependent on a forwarding link, the transmission power determination module may determine at least one transmission power value for the forwarding node 106 to use when transmitting over a forwarding link. The transmission power determination module may determine different transmission power values, and/or determine separate transmission power values in different ways, for different forwarding directions. For example, the transmission power determination module may determine one or more first transmission power values for the uplink direction when transmitting one or more uplink signals over the second forwarding link 208 to the wireless access node 104, and may determine or more second transmission power values for the downlink direction when transmitting one or more downlink signals over the third forwarding link 210 to the user device 102.

Additionally, for at least some embodiments where the power transmission value is dependent on a forwarding link, and the transmission is an uplink transmission in the uplink direction (i.e., the forwarding link is the second forwarding link 208), the transmission power determination module may determine a transmission power value based on a maximum transmission power, an expected target power at the wireless access node 104, and a path loss for the forwarding link. In addition, for at least some of these embodiments, the transmission power determination module may determine the transmission power value further based on at least one of: a bandwidth value for the forwarding link, a path loss compensation factor, or a closed-loop power control value. In addition or alternatively, for at least some of these embodiments, the transmission power determination module may determine a transmission power value for a particular beam index. For example, in some embodiments, the forwarding node 106, using its antenna 108, may be configured to perform beamforming or beam steering, and transmit using a selected beam of a plurality of beams. Each beam of the plurality of beams may have an associated beam index. The transmission power determination module may determine a transmission power value for a particular beam or beam index, and/or may determine a plurality of transmission power values, each for a respective one of a plurality of beams or beam indices. In other embodiments, the forwarding node 106 may not perform beamforming or beam steering, and/or may use only a single beam for its transmissions. For such embodiments, the transmission power determination module may determine a transmission power value that is not particular for any one particular beam or beam index. In addition or alternatively, the transmission power determination module may determine a transmission power value based on a minimum of the maximum transmission power and a candidate transmission power value. The candidate transmission power value may be based on the expected target power at the wireless access node 104, the path loss forward the forwarding link, and at least one of the bandwidth value for the forwarding link, the path loss compensation factor, or the closed-loop power control value. In particular of these embodiments, the transmission power determination module may determine a transmission power value for transmission on the second forwarding link 208 to the wireless access node 104 according to the following mathematical formula:

$${P}_{FL 2} ( b ) = min \{ {P}_{FL 2 , max} ( b ) , {P}_{O \_ FL 2} ( b ) + 10 {log}_{10} ( BW ) + {alpha}_{FL 2} * PL ( b ) + {f}_{FL 2} ( b ) \} \qquad ( 2 )$$

where b is a beam index, P_{FL2}(b) is the transmission power value for transmission on the second forwarding link 208 for the beam index b, P_{FL2,max}(b) is a maximum transmission power for transmission on the second forwarding link 208 for the beam index b, P_{O_FL2}(b) is the expected target power at the wireless access node 104 for transmission on the second forwarding link 208, 10 log₁₀(BW) is a bandwidth value for a given bandwidth BW of the transmission on the second forwarding link 208, alpha_{FL2} is the path loss compensation factor for the second forwarding link 208, PL(b) is the path loss for the second forwarding link 208 for the beam index b, and f_{FL2}(b) is the closed-loop power control value for the second forwarding link 208 for the beam index b. Accordingly, for these particular embodiments, the candidate transmission power value comprises a sum of the expected target power at the wireless access node 104 P_{O_FL2}(b), the bandwidth value for the given bandwidth BW 10 log₁₀(BW), a product of the path loss compensation factor alpha_{FL2} and the path loss for the second forwarding link 208 PL(b), and the closed-loop power control value for the second forwarding link 208 f_{FL2}(b). In other of these embodiments where the transmission power determination module does not determine transmission power values for particular beams or beam indices, the transmission power determination module may use mathematical formula (2), but the values are not particular to any beams or beam indices.

In further detail, in various embodiments, the beam index b may be an uplink reference signal (UL RS) index, such as a sounding reference signal (SRS) index corresponding to a spatial filter to be used for the transmission over the second forwarding link 208. The beam index b may not be used for embodiments, where the forwarding node 106 uses a single beam for transmitting on the second forwarding link 208, such as where the spatial filter it uses is a default spatial filter.

Additionally, the maximum transmission power for the second forwarding link 208 (per beam b if applicable) may be a value that does not exceed a maximum transmission power supported by the forwarding node 106 (such as by specified by a manufacturer of the forwarding node 106), a value for a single beam for transmission on the second forwarding link 208 that does not exceed the maximum transmission power for transmission on the second forwarding link 208, or a list of values for multiple beams for transmission on the second forwarding link 208, any one of which does not exceed the maximum transmission power for transmission on the second forwarding link 208.

Additionally, the expected target power (per beam b if applicable) at the wireless access node 104 (i.e., the base station side) may be a value for transmission on the second forwarding link 208, a list of values for transmission on the second forwarding link 208, one of which is selected by the wireless access node 104 using scheduling indication information, or a list of values for a single beam for transmission on the second forwarding link 208, one of which is selected by the wireless access node 104 using scheduling indication information.

Also, the bandwidth BW is a bandwidth used by the forwarding node 106 for transmitting or forwarding signals. In various embodiments, the bandwidth BW is a predefined value or a fixed value corresponding to a fixed system bandwidth. In addition or alternatively, in some embodiments, the bandwidth value 10 log₁₀(BW) may not be used by the transmission power determination module, such as in formula (2), such as if the bandwidth value is absorbed into the excepted target power.

In addition, the path loss compensation factor for the second forwarding link 208 may be a value for transmission on the second forwarding link 208. In some embodiments, the path loss compensation factor is a predefined value, such as one in some cases. In other examples, the path loss compensation factor may include a list of values for transmission on the second forwarding link 208, one of which is selected by the wireless access node 104 using scheduling information. Also, in various embodiments, the path loss may be a value that is reused from a path loss determined for communication on a control link, such as the first control link 202 or the second control link 204. Additionally, the closed-loop power control value may be provided by the wireless access node 104 using scheduling indication information. In some embodiments, the closed-loop power control value may not be used to determine a transmission power value, such as if the wireless channel between the wireless access node 104 and the forwarding node 106 is sufficiently stable. An example of a sufficiently stable wireless channel is a line-of-sight (LOS) path.

Additionally, for at least some embodiments where the power transmission value is dependent on a forwarding link, and the transmission is a downlink transmission in the downlink direction (i.e., the forwarding link is the third forwarding link 210), the transmission power determination module may determine a transmission power value in one of two ways. In a first way, the transmission power value may be based on a maximum transmission power for transmission on the third forwarding link 210, a received signal power of the forwarding node 106 on the first forwarding link 206, and an amplification gain. In particular of these embodiments, the transmission power determination module may determine the transmission power value to be, or to be based on, a minimum of the maximum transmission power and a sum of the received signal power and the amplification gain, such as in accordance with the following mathematical formulas:

$${P}_{FN} = min \{ {P}_{FN 3 , max} , {P}_{Rx} + {g}_{amp} \} , \qquad ( 3 )$$

where P_{FL3} is the transmission power value for transmission on the third forwarding link 210, P_{Rx} is the received signal power of the forwarding node 106 on the first forwarding link 206, and gₐₘₚ is the amplification gain.

In a second way, the transmission power determination module may determine a transmission power value for transmission on the third forwarding link 210 based on a maximum transmission power for the third forwarding link 210, a received signal power of the forwarding node 106 for the first forwarding link 206, a bandwidth value for transmission on the third forwarding link 208, and a path loss for the third forwarding link 210. In particular of these embodiments, the transmission power determination module may determine the transmission power value further based on a path loss compensation factor for the third forwarding link 210. For example, for the second way, the transmission power determination module may determine a transmission power value for transmission on the third forwarding link 210 based on a minimum of the maximum transmission power for the third forwarding link 210, and a candidate transmission power value comprising a sum of the received signal power, the bandwidth value for transmission on the third forwarding link 208, and a product of the path loss compensation factor, and the path loss, such as according to the following mathematical formula:

$${P}_{FL 3} = min \{ {P}_{FL 3 , max} , {P}_{Rx} + 10 {log}_{10} ( BW ) + {alpha}_{FL 3} * PL \} , \qquad ( 4 )$$

where P_{FL3} is the transmission power value for transmission on the third forwarding link 210, P_{FL3,max} is the maximum transmission power for transmission on the third forwarding link 210, P_{Rx} is the received signal power of the forwarding node 106 for the first forwarding link 206, and the bandwidth BW is a bandwidth that the forwarding node 106 uses for transmitting or forwarding, which may be a predefined value, such as if the forwarding node 106 transits or forwards signals with a predefined bandwidth or a fixed bandwidth, such as a fixed bandwidth for downlink common signals. In addition, in some embodiments, the path loss compensation factor may be a predefined value, such as one, and the path loss may be a path loss for the first forwarding link 206, which may be reused from a path loss determined for communication on a control link, such as the first control link 202 or the second control link 204.

At block 306, the forwarding node 106 may transmit the signal to the second communication node according to the transmission power value it determined at block 304. As previously described, if the signal is an uplink signal received from the user device 102, then the forwarding node 106 may transmit or forward the signal on the second forwarding link 208 to the wireless access node 104. If the signal is a downlink signal received from the wireless access node 104, then the forwarding node may transmit or forward the signal on the third forwarding link 210 to the user device 102.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: receiving, with a forwarding node, a signal from a first communication node; determining, with the forwarding node, a transmission power value for transmission of the signal, the transmission power value dependent on a forwarding mode of the forwarding node or a forwarding link between the forwarding node and a second communication node; and transmitting, with the forwarding node, the signal to the second communication node according to the transmission power value.

A second aspect includes the first aspect, and further includes wherein the forwarding mode comprises one of a plurality of operating modes, the plurality of operating modes further comprising a control mode in which the forwarding node communicates control information with a wireless access node.

A third aspect includes any of the first or second aspects, and further includes wherein the forwarding link comprises a first forwarding link, the first forwarding link comprising one of a plurality of forwarding links, the plurality of forwarding links further comprising a second forwarding link between the forwarding node and the first communication node.

A fourth aspect includes any of the first through third aspects, and further includes wherein the transmission power value is dependent on the forwarding mode, and the transmission power value is based on a maximum transmission power, a received signal power of the forwarding node, and an amplification gain.

A fifth aspect includes the fourth aspect, and further includes wherein the transmission power value is based on a minimum of the maximum transmission power and a sum of the received signal power of the forwarding node and the amplification gain.

A sixth aspect includes any of the fourth or fifth aspects, and further includes wherein a value for the maximum transmission power is applicable for both an uplink direction and a downlink direction.

A seventh aspect includes any of the fourth or fifth aspects, and further includes: determining, with the forwarding node, a first value for the maximum transmission power in response to the signal comprising an uplink signal; and determining, with the forwarding node, a second value for the maximum transmission power in response to the signal comprising a downlink signal.

An eighth aspect includes any of the fourth through seventh aspects, and further includes: receiving, with the forwarding node, a value for the maximum transmission power from a wireless access node, wherein the first communication node or the second communication node comprises the wireless access node.

A ninth aspect includes the eighth aspect, and further includes: receiving, with the forwarding node, a forwarding direction flag from the wireless access node, the forwarding direction flag indicating whether the value for the maximum transmission power is for an uplink direction or a downlink direction.

A tenth aspect includes any of the eighth or ninth aspects, and further includes wherein receiving the value for the maximum transmission power comprises receiving, with the forwarding node, the value for the maximum transmission power from the wireless access node in response to the signal comprising a downlink signal, and determining, with the forwarding node, that the value for the maximum transmission power is a value of a maximum transmission power for a control link between the forwarding node and the wireless access node in response to the signal comprising an uplink signal.

An eleventh aspect includes any of the fourth through tenth aspects, and further includes: determining, with the forwarding node, a value for the amplification gain irrespective of whether the signal comprises an uplink signal or a downlink signal.

A twelfth aspect includes any of the fourth through tenth aspects, and further includes: determining, with the forwarding node, a first value for the amplification gain in response to the signal comprising an uplink signal; and determining, with the forwarding node, a second value for the amplification gain in response to the signal comprising a downlink signal.

A thirteenth aspect includes any of the fourth through twelfth aspects, and further includes: receiving, with the forwarding node, a value for the amplification gain from a wireless access node, wherein the first communication node or the second communication node comprises the wireless access node.

A fourteenth aspect includes the thirteenth aspect, and further includes: receiving, with the forwarding node, a forwarding direction flag from the wireless access node, the forwarding direction flag indicating whether the value for the amplification gain is for an uplink direction or a downlink direction.

A fifteenth aspect includes any of the first through third aspects, and further includes wherein the forwarding link is from the forwarding node to a wireless access node, the first communication node or the second communication node comprising the wireless access node.

A sixteenth aspect includes the fifteenth aspect, and further includes wherein the transmission power is for a particular beam index.

A seventeenth aspect includes any of the fifteenth or sixteenth aspects, and further includes wherein a value of the transmission power is based on a maximum transmission power, an expected target power at the wireless access node, and a path loss for the forwarding link.

An eighteenth aspect includes the seventeenth aspect and further includes wherein the value of the transmission power is further based on at least one of: a bandwidth value for the forwarding link, a path loss compensation factor, or a closed-loop power control value.

A nineteenth aspect includes the eighteenth aspect, and further includes wherein the value of the transmission power is based on a minimum of the maximum transmission power and a candidate transmission power value based on the expected target power at the wireless access node, the path loss for the forwarding link, and at least one of the bandwidth value for the forwarding link, the path loss compensation factor, or the closed-loop power control value.

A twentieth aspect includes the nineteenth aspect, and further includes wherein the candidate transmission power value comprises a sum of the expected target power at the wireless access node, the bandwidth value for the forwarding link, a product of the path loss compensation factor and the path loss for the forwarding link, and the closed-loop power control value.

A twenty-first aspect includes any of the first through third aspects, and further includes wherein the forwarding link is from the forwarding node to a user device, the first communication node or the second node comprising the user device comprising the user device.

A twenty-second aspect includes the twenty-first aspect, and further includes wherein the forwarding link comprises a first forwarding link, and wherein the transmission power value is based on a maximum transmission power for the first forwarding link, a received signal power of the forwarding node for a second forwarding link from a wireless access node to the forwarding node, and an amplification gain.

A twenty-third aspect includes the twenty-second aspect, and further includes wherein the transmission power value is based on a minimum of the maximum transmission power and a sum of the received signal power and the amplification gain.

A twenty-fourth aspect includes the twenty-first aspect, and further includes wherein the forwarding link comprises a first forwarding link, and wherein the transmission power value is based on a maximum transmission power for the first forwarding link, a received signal power of the forwarding node for a second forwarding link from a wireless access node to the forwarding node, a bandwidth value for the first forwarding link, and a path loss for the second forwarding link.

A twenty-fifth aspect includes the twenty-fourth aspect, and further includes wherein the transmission power value is further based on a path loss compensation factor for the first forwarding link.

A twenty-sixth aspect includes the twenty-fifth aspect, and further includes wherein the transmission power value is based on a minimum of the maximum transmission power and a candidate transmission power value comprising a sum of the received signal power, the bandwidth value, and a product of the path loss compensation factor and the path loss.

A twenty-seventh aspect includes a wireless communications apparatus comprising a processor and a memory, wherein the processor is configured to read code from the memory to implement any of the first through twenty-sixth aspects.

A twenty-eighth aspect includes a computer program product comprising a computer-readable program medium comprising code stored thereupon, the code, when executed by a processor, causing the processor to implement any of the first through twenty-sixth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, with a forwarding node, a signal from a first communication node;
determining, with the forwarding node, a transmission power value for transmission of the signal, the transmission power value dependent on a forwarding mode of the forwarding node or a forwarding link between the forwarding node and a second communication node; and
transmitting, with the forwarding node, the signal to the second communication node according to the transmission power value.

2. The method of claim 1, wherein the forwarding mode comprises one of a plurality of operating modes, the plurality of operating modes further comprising a control mode in which the forwarding node communicates control information with a wireless access node.

3. The method of claim 1, wherein the forwarding link comprises a first forwarding link, the first forwarding link comprising one of a plurality of forwarding links, the plurality of forwarding links further comprising a second forwarding link between the forwarding node and the first communication node.

4. The method of claim 1, wherein the transmission power value is dependent on the forwarding mode, and the transmission power value is based on a maximum transmission power, a received signal power of the forwarding node, and an amplification gain.

5. The method of claim 4, wherein the transmission power value is based on a minimum of the maximum transmission power and a sum of the received signal power of the forwarding node and the amplification gain.

6. The method of claim 4, wherein a value for the maximum transmission power is applicable for both an uplink direction and a downlink direction.

7. The method of claim 4, further comprising:
determining, with the forwarding node, a first value for the maximum transmission power in response to the signal comprising an uplink signal; and
determining, with the forwarding node, a second value for the maximum transmission power in response to the signal comprising a downlink signal.

8. The method of claim 4, further comprising:
receiving, with the forwarding node, a value for the maximum transmission power from a wireless access node, wherein the first communication node or the second communication node comprises the wireless access node.

9. The method of claim 8, further comprising:
receiving, with the forwarding node, a forwarding direction flag from the wireless access node, the forwarding direction flag indicating whether the value for the maximum transmission power is for an uplink direction or a downlink direction.

10. The method of claim 8, wherein receiving the value for the maximum transmission power comprises receiving, with the forwarding node, the value for the maximum transmission power from the wireless access node in response to the signal comprising a downlink signal, the method further comprising:
determining, with the forwarding node, that the value for the maximum transmission power is a value of a maximum transmission power for a control link between the forwarding node and the wireless access node in response to the signal comprising an uplink signal.

11. The method of claim 4, further comprising:
determining, with the forwarding node, a value for the amplification gain irrespective of whether the signal comprises an uplink signal or a downlink signal.

12. The method of claim 4, further comprising:
determining, with the forwarding node, a first value for the amplification gain in response to the signal comprising an uplink signal; and
determining, with the forwarding node, a second value for the amplification gain in response to the signal comprising a downlink signal.

13. The method of claim 4, further comprising:
receiving, with the forwarding node, a value for the amplification gain from a wireless access node, wherein the first communication node or the second communication node comprises the wireless access node.

14. The method of claim 13, further comprising:
receiving, with the forwarding node, a forwarding direction flag from the wireless access node, the forwarding direction flag indicating whether the value for the amplification gain is for an uplink direction or a downlink direction.

15. The method of claim 1, wherein the transmission power value is dependent on the forwarding link, and the forwarding link is from the forwarding node to a wireless access node, the first communication node or the second communication node comprising the wireless access node.

16. The method of claim 15, wherein the transmission power is for a particular beam index.

17. The method of claim 15, wherein a value of the transmission power is based on a maximum transmission power, an expected target power at the wireless access node, and a path loss for the forwarding link.

18. The method of claim 17, wherein the value of the transmission power is further based on at least one of: a bandwidth value for the forwarding link, a path loss compensation factor, or a closed-loop power control value.

19. The method of claim 18, wherein the value of the transmission power is based on a minimum of the maximum transmission power and a candidate transmission power value based on the expected target power at the wireless access node, the path loss for the forwarding link, and at least one of the bandwidth value for the forwarding link, the path loss compensation factor, or the closed-loop power control value.

20. The method of claim 19, wherein the candidate transmission power value comprises a sum of the expected target power at the wireless access node, the bandwidth value for the forwarding link, a product of the path loss compensation factor and the path loss for the forwarding link, and the closed-loop power control value.
